(19) United States
(12) Patent Application Publication
(10) Pub. No.: US 2026/0058830 A1
(43) Pub. Date: Feb. 26, 2026

(54) FACILITATING PRIVATE COMMUNICATIONS BETWEEN APPLICATIONS OVER AN UNTRUSTED NETWORK WHILE ENSURING TRACEABILITY

(71) Applicant: JPMorgan Chase Bank, N.A., New York, NY (US)

(72) Inventors: Sudeepto Kumar ROY, Bengaluru (IN); Mark A. JACKSON, Westerville, OH (US); Myron A. WIENEKE, Mckinney, TX (US)

(73) Assignee: JPMorgan Chase Bank, N.A., New York, NY (US)

(21) Appl. No.: 19/300,775

(22) Filed: Aug. 15, 2025

(30) Foreign Application Priority Data
Aug. 26, 2024 (IN) 202411064212

(51) Int. Cl. H04L 9/32; H04L 9/08

(52) U.S. Cl. CPC H04L 9/3263; H04L 9/0838

(57) ABSTRACT

A method for implementing an inter-cluster network security tool that facilitates private communications between a first private distributed application cluster and a set of private distributed application clusters within a secured enterprise network. The method may comprise utilizing a first local cluster certificate to generate a first shared key; receiving the first encrypted communication, utilizing the first shared key to decrypt the first encrypted communication, utilizing a second shared key to generate a second encrypted communication, and transmitting the second encrypted communication to a first remote inter-cluster ingress gateway that corresponds to a first remote private distributed application cluster from among the set of private distributed application clusters.

### CROSS-REFERENCE TO RELATED APPLICATIONS

This application claims priority benefit from Indian Application No. 202411064212, filed Aug. 26, 2024, which is hereby incorporated by reference in its entirety.

### BACKGROUND

### 1. Field of the Invention

The field of the invention disclosed herein generally relates to facilitating private communications between applications that do not trust one another and, more particularly, to a method, system, and computer-readable medium for implementing technology that facilitates encrypted communications between private distributed application clusters that do not trust one another.

### 2. Background of the Invention

Today's communication networks include computer systems of organizations and, thereby, also include their organization's proprietary information, such as proprietary: data, procedures, policies, communications, business models, intellectual property, software, applications, products, etc. However, the demands of the communication network computer systems of these organizations grow exponentially with respect to their size and complexity.

Therefore, conventional approaches to scaling existing communication network computer systems, to account for the organizational growth that is being ushered in by the information age, are inefficient. For example, existing communication network computer systems require an exorbitant amount of resources for communication networks that require connections between a large number of internal systems that do not trust one another.

Accordingly, there is a need in the field of the present invention for a technical solution to the foregoing drawbacks in existing technology for facilitating secure communications between entities that do not trust one another, particularly for communications that are susceptible to eavesdropping, spoofing, and other unwanted behaviors, for example.

### SUMMARY

The present disclosure, through one or more of its various aspects, embodiments, and/or specific features or sub-component, provides, inter alia, various systems, servers, devices, methods, media, programs and platforms for implementing an inter-cluster network security tool that facilitates encrypted communications between private distributed application clusters that do not trust one another.

According to an aspect of the present disclosure, a method is provided for implementing an inter-cluster network security tool that facilitates private communications between a first private distributed application cluster and a set of private distributed application clusters within a secured enterprise network. The method may comprise: utilizing, at a first inter-cluster egress gateway, a first local cluster certificate to generate a first shared key; receiving, at the first inter-cluster egress gateway and from at least a first distributed application of the first private distributed application cluster within the secured enterprise network, a first encrypted communication; reproducing, at the first inter-cluster egress gateway, the first communication by utilizing the first shared key to decrypt the first encrypted communication; generating, at the first inter-cluster egress gateway, a second encrypted communication by utilizing a first enterprise certificate to generate a second shared key and utilizing the second shared key to re-encrypt a first communication; and transmitting the second encrypted communication to a first target inter-cluster ingress gateway that respectively corresponds to a first target private distributed application cluster from among the set of private distributed application clusters. The first encrypted communication may be generated by utilizing the first shared key to encrypt a first communication.

In the method, the first local cluster certificate may be securely registered within a distributed enterprise control plane that configured the first inter-cluster egress gateway with the first local cluster certificate and the first enterprise certificate.

The method may further comprise: before generating the second shared key, mutually authenticating with the at least the first distributed application and utilizing a first encrypted session to communicate with the at least the first distributed application. In the method, the transmitting the second encrypted communication may comprise: before generating the second shared key, utilizing the first enterprise certificate to mutually authenticate with the first target inter-cluster ingress gateway and utilizing a second encrypted session to communicate with the first target inter-cluster ingress gateway.

In the method, the first enterprise certificate and at least a second enterprise certificate may be generated by an enterprise certificate authority.

In the method, a superset of clusters may comprise each cluster within the secured enterprise network, and cluster-to-internet protocol (IP) address mappings may identify each cluster from among the superset of clusters and may associate each cluster with respectively corresponding IP address ranges.

The method may further comprise: in response to the receiving the first encrypted communication, determining that the first encrypted communication has been received from the at least the first distributed application, utilizing a header of the first encrypted communication to determine that the first target private distributed application cluster is a destination of the first communication and, before the second encrypted communication is transmitted, verifying that the at least the first distributed application is authorized to communicate with the first private distributed application cluster.

In the method, the generating the second encrypted communication may comprise: obtaining, from the header of the first encrypted communication, at least one from among a source certificate identifier that identifies the first local cluster certificate and a first source IP address of the at least the first distributed application; and populating a header of the second encrypted communication with the at least one from among the source certificate identifier and the first source IP address.

The method may further comprise: receiving, at a first inter-cluster ingress gateway and from a first remote inter-cluster egress gateway that corresponds to a first remote private distributed application cluster from among the set of private distributed application clusters, a third encrypted communication; reproducing, at the first inter-cluster ingress gateway, a second communication by utilizing the third shared key to decrypt the third encrypted communication; generating, at the first inter-cluster ingress gateway, a fourth encrypted communication by utilizing the first shared key to re-encrypt the second communication; and transmitting the fourth encrypted communication to at least one distributed application of the first private distributed application cluster. The third encrypted communication may be generated by utilizing a third shared key to encrypt the second communication, and the third shared key may be generated by utilizing a second enterprise certificate.

In the method, the at least one distributed application may comprise at least one from among the at least the first distributed application and a second distributed application of the first private distributed application cluster.

The method may further comprise, before generating the third shared key, mutually authenticating with the first remote inter-cluster egress gateway and utilizing a third encrypted session to communicate with the first remote inter-cluster egress gateway, and the transmitting the fourth encrypted communication may comprise communicating with the at least one distributed application by utilizing a first encrypted session.

In the method: the first encrypted communication may be received, by the first inter-cluster egress gateway, from a first sidecar proxy of the first private distributed application cluster; the fourth encrypted communication may be transmitted, by the first inter-cluster ingress gateway, to at least one sidecar proxy of the first private distributed application cluster; and the at least one sidecar proxy may comprise at least one from among the first sidecar proxy and a second sidecar proxy of the first private distributed application cluster.

The method may further comprise: in response to the receiving the third encrypted communication, determining that the third encrypted communication has been received from the first remote inter-cluster egress gateway, utilizing a header of the third encrypted communication to determine that the at least one distributed application is a destination of the second communication and, before the third encrypted communication is transmitted, verifying that the first remote inter-cluster egress gateway is authorized to communicate with the at least one distributed application.

In the method, the generating the fourth encrypted communication may comprise: obtaining, from the header of the third encrypted communication, at least one from among a remote certificate identifier that identifies a first remote cluster certificate of the first remote private distributed application cluster, and a first remote IP address of the first remote private distributed application cluster; and populating a header of the fourth encrypted communication with the at least one from among the remote certificate identifier and the first remote IP address.

In the method, the first distributed application may obtain, from the header of the fourth encrypted communication, the at least one from among the remote certificate identifier and the first remote IP address.

In the method, a superset of clusters may comprise each cluster within the secured enterprise network, cluster-to-IP address mappings may identify each cluster from among the superset of clusters and may associate each cluster with respectively corresponding IP address ranges, and the first distributed application may utilize the cluster-to-IP address mappings to identify which cluster of the secured enterprise network is associated with the first remote IP address.

According to another aspect of the present disclosure, a system is provided to implement an inter-cluster network security tool that facilitates private communications between a first private distributed application cluster and a set of private distributed application clusters within a secured enterprise network. The system may comprise a processor and memory storing instructions that, when executed by the processor, cause the processor to perform operations that may comprise: utilizing, at a first inter-cluster egress gateway, a first local cluster certificate to generate a first shared key; receiving, at the first inter-cluster egress gateway and from at least a first distributed application of the first private distributed application cluster within the secured enterprise network, a first encrypted communication; reproducing, at the first inter-cluster egress gateway, the first communication by utilizing the first shared key to decrypt the first encrypted communication; generating, at the first inter-cluster egress gateway, a second encrypted communication by utilizing a first enterprise certificate to generate a second shared key and utilizing the second shared key to re-encrypt a first communication; and transmitting the second encrypted communication to a first target inter-cluster ingress gateway that respectively corresponds to a first target private distributed application cluster from among the set of private distributed application clusters. The first encrypted communication may be generated by utilizing the first shared key to encrypt a first communication.

In the system, the first local cluster certificate may be securely registered within a distributed enterprise control plane that configured the first inter-cluster egress gateway with the first local cluster certificate and the first enterprise certificate.

In the system, when executed, the instructions may cause the processor to perform further operations that comprise mutually authenticating with the at least the first distributed application and utilizing a first encrypted session to communicate with the at least the first distributed application, before generating the second shared key, and the instructions may cause the transmitting the second encrypted communication to comprise: before generating the second shared key, utilizing the first enterprise certificate to mutually authenticate with the first target inter-cluster ingress gateway and utilizing a second encrypted session to communicate with the first target inter-cluster ingress gateway.

In the system, the first enterprise certificate and at least a second enterprise certificate may have been generated by an enterprise certificate authority.

In the system, a superset of clusters may comprise each cluster within the secured enterprise network, and cluster-to-IP address mappings may identify each cluster from among the superset of clusters and may associate each cluster with respectively corresponding IP address ranges.

In the system, when executed, the instructions may cause the processor to perform further operations that comprise: determining that the first encrypted communication has been received from the at least the first distributed application, in response to the receiving the first encrypted communication; utilizing a header of the first encrypted communication to determine that the first target private distributed application cluster is a destination of the first communication; and verifying that the at least the first distributed application is authorized to communicate with the first private distributed application cluster, before the second encrypted communication is transmitted.

In the system, when executed by the processor, the instructions may cause the generating the second encrypted communication to comprise: obtaining, from the header of the first encrypted communication, at least one from among a source certificate identifier that identifies the first local cluster certificate and a first source IP address of the at least the first distributed application; and populating a header of the second encrypted communication with the at least one from among the source certificate identifier and the first source IP address.

In the system, when executed, the instructions may cause the processor to perform further operations that comprise: receiving a third encrypted communication at a first inter-cluster ingress gateway and from a first remote inter-cluster egress gateway that corresponds to a first remote private distributed application cluster from among the set of private distributed application clusters; reproducing, at the first inter-cluster ingress gateway, a second communication by utilizing the third shared key to decrypt the third encrypted communication; generating, at the first inter-cluster ingress gateway, a fourth encrypted communication by utilizing the first shared key to re-encrypt the second communication; and transmitting the fourth encrypted communication to at least one distributed application of the first private distributed application cluster. In the system, the third encrypted communication may be generated by utilizing a third shared key to encrypt the second communication, and the third shared key may be generated by utilizing a second enterprise certificate.

In the system, the at least one distributed application may comprise at least one from among the at least the first distributed application and a second distributed application of the first private distributed application cluster.

In the system, when executed, the instructions may cause the processor to perform further operations that comprise: mutually authenticating with the first remote inter-cluster egress gateway and utilizing a third encrypted session to communicate with the first remote inter-cluster egress gateway, before generating the third shared key, and the instructions may cause the transmitting the fourth encrypted communication to comprise communicating with the at least one distributed application by utilizing a first encrypted session.

In the system, the first encrypted communication may be received from a first sidecar proxy of the first private distributed application cluster by the first inter-cluster egress gateway, the fourth encrypted communication may be transmitted to at least one sidecar proxy of the first private distributed application cluster by the first inter-cluster ingress gateway, and the at least one sidecar proxy may comprise at least one from among the first sidecar proxy and a second sidecar proxy of the first private distributed application cluster.

In the system, when executed, the instructions may cause the processor to perform further operations that comprise, in response to the receiving the third encrypted communication: determining that the third encrypted communication has been received from the first remote inter-cluster egress gateway, utilizing a header of the third encrypted communication to determine that the at least one distributed application is a destination of the second communication and, before the third encrypted communication is transmitted, verifying that the first remote inter-cluster egress gateway is authorized to communicate with the at least one distributed application.

In the system, when executed by the processor, the instructions may cause the generating the fourth encrypted communication to comprise: obtaining, from the header of the third encrypted communication, at least one from among a remote certificate identifier that identifies a first remote cluster certificate of the first remote private distributed application cluster, and a first remote IP address of the first remote private distributed application cluster; and populating a header of the fourth encrypted communication with the at least one from among the remote certificate identifier and the first remote IP address.

In the system, the first distributed application may obtain, from the header of the fourth encrypted communication, the at least one from among the remote certificate identifier and the first remote IP address.

In the system, a superset of clusters may comprise each cluster within the secured enterprise network, cluster-to-IP address mappings may identify each cluster from among the superset of clusters and may associate each cluster with respectively corresponding IP address ranges, and the first distributed application may utilize the cluster-to-IP address mappings to identify which cluster of the secured enterprise network is associated with the first remote IP address.

According to yet another aspect of the present disclosure, a non-transitory computer-readable medium is provided to implement an inter-cluster network security tool that facilitates private communications between a first private distributed application cluster and a set of private distributed application clusters within a secured enterprise network. The non-transitory computer-readable medium may store instructions that, when executed by a processor, cause the processor to perform operations that may comprise: utilizing, at a first inter-cluster egress gateway, a first local cluster certificate to generate a first shared key; receiving, at the first inter-cluster egress gateway and from at least a first distributed application of the first private distributed application cluster within the secured enterprise network, a first encrypted communication; reproducing, at the first inter-cluster egress gateway, the first communication by utilizing the first shared key to decrypt the first encrypted communication; generating, at the first inter-cluster egress gateway, a second encrypted communication by utilizing a first enterprise certificate to generate a second shared key and utilizing the second shared key to re-encrypt a first communication; and transmitting the second encrypted communication to a first target inter-cluster ingress gateway that respectively corresponds to a first target private distributed application cluster from among the set of private distributed application clusters. The first encrypted communication may be generated by utilizing the first shared key to encrypt a first communication.

In the computer-readable medium, the first local cluster certificate may be securely registered within a distributed enterprise control plane that configured the first inter-cluster egress gateway with the first local cluster certificate and the first enterprise certificate.

In the computer-readable medium, when executed, the instructions may cause the processor to perform further operations that comprise mutually authenticating with the at least the first distributed application and utilizing a first encrypted session to communicate with the at least the first distributed application, before generating the second shared key, and the instructions may cause the transmitting the second encrypted communication to comprise: before generating the second shared key, utilizing the first enterprise certificate to mutually authenticate with the first target inter-cluster ingress gateway and utilizing a second encrypted session to communicate with the first target inter-cluster ingress gateway.

In the computer-readable medium, the first enterprise certificate and at least a second enterprise certificate may have been generated by an enterprise certificate authority.

In the computer-readable medium, a superset of clusters may comprise each cluster within the secured enterprise network, and cluster-to-IP address mappings may identify each cluster from among the superset of clusters and may associate each cluster with respectively corresponding IP address ranges.

In the computer-readable medium, when executed, the instructions may cause the processor to perform further operations that comprise: determining that the first encrypted communication has been received from the at least the first distributed application, in response to the receiving the first encrypted communication; utilizing a header of the first encrypted communication to determine that the first target private distributed application cluster is a destination of the first communication; and verifying that the at least the first distributed application is authorized to communicate with the first private distributed application cluster, before the second encrypted communication is transmitted.

In the computer-readable medium, when executed by the processor, the instructions may cause the generating the second encrypted communication to comprise: obtaining, from the header of the first encrypted communication, at least one from among a source certificate identifier that identifies the first local cluster certificate and a first source IP address of the at least the first distributed application; and populating a header of the second encrypted communication with the at least one from among the source certificate identifier and the first source IP address.

In the computer-readable medium, when executed, the instructions may cause the processor to perform further operations that comprise: receiving a third encrypted communication at a first inter-cluster ingress gateway and from a first remote inter-cluster egress gateway that corresponds to a first remote private distributed application cluster from among the set of private distributed application clusters; reproducing, at the first inter-cluster ingress gateway, a second communication by utilizing the third shared key to decrypt the third encrypted communication; generating, at the first inter-cluster ingress gateway, a fourth encrypted communication by utilizing the first shared key to re-encrypt the second communication; and transmitting the fourth encrypted communication to at least one distributed application of the first private distributed application cluster. In the computer-readable medium, the third encrypted communication may be generated by utilizing a third shared key to encrypt the second communication, and the third shared key may be generated by utilizing a second enterprise certificate.

In the computer-readable medium, the at least one distributed application may comprise at least one from among the at least the first distributed application and a second distributed application of the first private distributed application cluster.

In the computer-readable medium, when executed, the instructions may cause the processor to perform further operations that comprise: mutually authenticating with the first remote inter-cluster egress gateway and utilizing a third encrypted session to communicate with the first remote inter-cluster egress gateway, before generating the third shared key, and the instructions may cause the transmitting the fourth encrypted communication to comprise communicating with the at least one distributed application by utilizing a first encrypted session.

In the computer-readable medium, the first encrypted communication may be received from a first sidecar proxy of the first private distributed application cluster by the first inter-cluster egress gateway, the fourth encrypted communication may be transmitted to at least one sidecar proxy of the first private distributed application cluster by the first inter-cluster ingress gateway, and the at least one sidecar proxy may comprise at least one from among the first sidecar proxy and a second sidecar proxy of the first private distributed application cluster.

In the computer-readable medium, when executed, the instructions may cause the processor to perform further operations that comprise, in response to the receiving the third encrypted communication: determining that the third encrypted communication has been received from the first remote inter-cluster egress gateway, utilizing a header of the third encrypted communication to determine that the at least one distributed application is a destination of the second communication and, before the third encrypted communication is transmitted, verifying that the first remote inter-cluster egress gateway is authorized to communicate with the at least one distributed application.

In the computer-readable medium, when executed by the processor, the instructions may cause the generating the fourth encrypted communication to comprise: obtaining, from the header of the third encrypted communication, at least one from among a remote certificate identifier that identifies a first remote cluster certificate of the first remote private distributed application cluster, and a first remote IP address of the first remote private distributed application cluster; and populating a header of the fourth encrypted communication with the at least one from among the remote certificate identifier and the first remote IP address.

In the computer-readable medium, the first distributed application may obtain, from the header of the fourth encrypted communication, the at least one from among the remote certificate identifier and the first remote IP address.

In the computer-readable medium, a superset of clusters may comprise each cluster within the secured enterprise network, cluster-to-IP address mappings may identify each cluster from among the superset of clusters and may associate each cluster with respectively corresponding IP address ranges, and the first distributed application may utilize the cluster-to-IP address mappings to identify which cluster of the secured enterprise network is associated with the first remote IP address.

Accordingly, the invention disclosed herein provides a novel approach to facilitating encrypted communications between private application clusters that do not trust one another.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 depicts a diagram of an exemplary computer system.

FIG. 2 depicts a diagram of an exemplary network environment for facilitating private communications between enterprise clusters that do not trust one another.

FIG. 3 depicts a diagram of an exemplary perspective of a network environment that facilitates private communications between enterprise clusters that do not trust one another.

FIG. 4 depicts a flowchart of an exemplary process for facilitating private communications between enterprise clusters that do not trust one another.

FIG. 5 depicts a diagram of an exemplary perspective of an enterprise network environment that facilitates private communications between enterprise clusters that do not trust one another.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

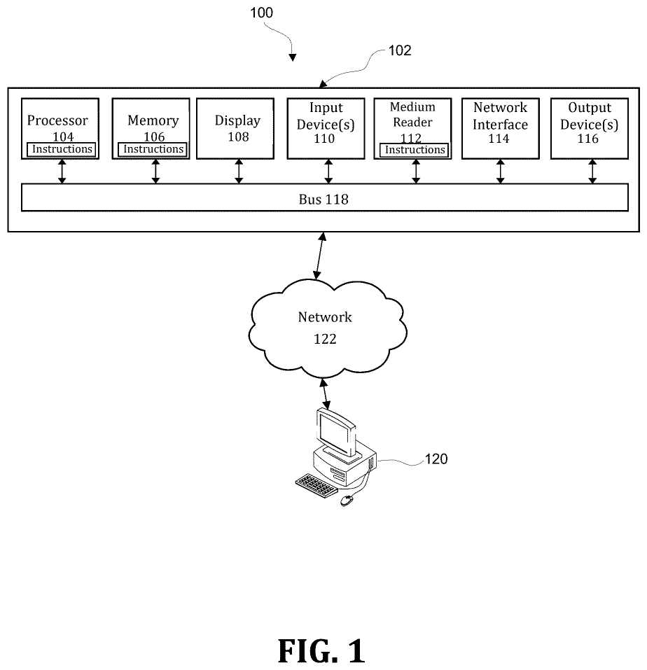

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blue-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing an inter-cluster network security tool that facilitates private communications between a first private distributed application cluster and a set of private distributed application clusters within a secured enterprise network.

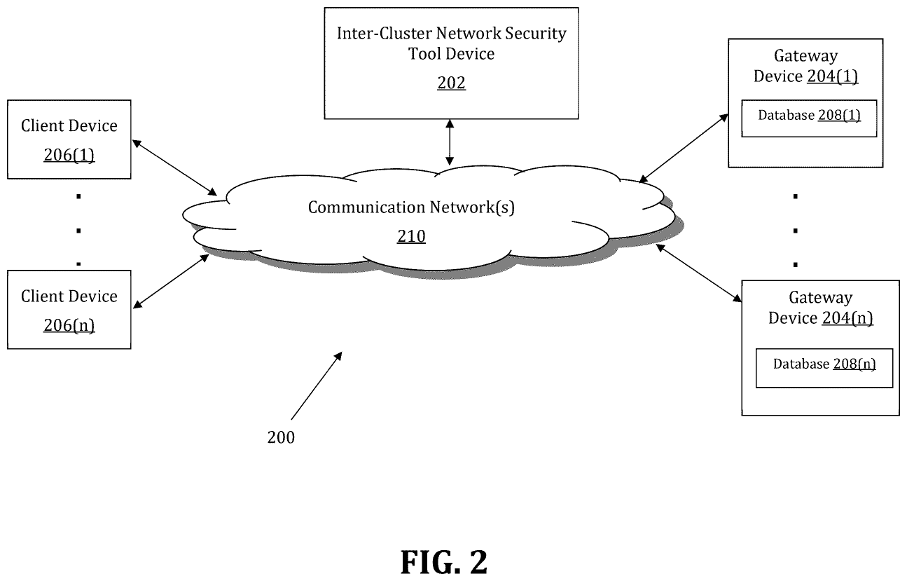

Referring to FIG. 2, a schematic of an exemplary network environment 200 for facilitating private communications between enterprise clusters that do not trust one another. In an exemplary embodiment, an inter-cluster network security tool may be implemented on any networked computer platform, such as, for example, a personal computer (PC).

A method for implementing a tool that facilitates private communications between applications that do not trust one another, may be implemented by an inter-cluster network security tool (INST) device 202. The INST device 202 may be the same or similar to the computer system 102 as described with respect to FIG. 1. The INST device 202 may be a rack-mounted server in a datacenter, an embedded microcontroller (MCU) in an electronic device, or another type of headless system, which is a computer system or device that is configured to operate without a monitor, keyboard and mouse. The INST device 202 may store one or more applications that can include executable instructions that, when executed by the INST device 202, cause the INST device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the INST device 202 itself, may be located in virtual server(s) running in a cloud-based computing environment rather than being tied to one or more specific physical network computing devices. Also, the application(s) may be running in one or more virtual machines (VMs) executing on the INST device 202. Additionally, in one or more embodiments of this technology, virtual machine(s) running on the INST device 202 may be managed or supervised by a hypervisor.

In the network environment 200 of FIG. 2, the INST device 202 is coupled to a plurality of gateway devices 204(1)-204(n) that hosts a plurality of databases 208(1)-208(n), and also to a plurality of client devices 206(1)-206(n) via communication network(s) 210. A communication interface of the INST device 202, such as the network interface 114 of the computer system 102 of FIG. 1, operatively couples and communicates between the INST device 202, the gateway devices 204(1)-204(n), and/or the client devices 206(1)-206(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the INST device 202, the gateway devices 204(1)-204(n), and/or the client devices 206(1)-206(n) may be coupled together via other topologies. Additionally, the network environment 200 may include other network devices such as one or more routers and/or switches, for example, which are well known in the art and thus will not be described herein. This technology provides a number of advantages including methods, computer readable media, and INST devices that implement a method for an inter-cluster network security tool that facilitates private communications between: a set of remote gateway devices that respectively correspond to a secured enterprise network's set of private distributed application clusters; and a cluster of private applications that are locally hosted on secured enterprise client devices, such as client devices 206(1)-206(n), for example.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical”and/or “virtual”locale.

The INST device 202 may be a standalone device or integrated with one or more other devices or apparatuses, such as one or more of the gateway devices 204(1)-204(n), for example. In one particular example, the INST device 202 may include or be hosted by one of the gateway devices 204(1)-204(n), and other arrangements are also possible. As another example, the INST device 202 may be integrated with one or more other devices or apparatuses, such as one or more of the client devices 206(1)-206(n). Moreover, one or more of the devices of the INST device 202 may be in a same or a different communication network including one or more public, private, or cloud networks, for example.

The plurality of gateway devices 204(1)-204(n) may be the same or similar to the computer system 102 or the computer device 120 as described with respect to FIG. 1, including any features or combination of features described with respect thereto. For example, any of the gateway devices 204(1)-204(n) may include, among other features, one or more processors, memories and communication interfaces, which are coupled together by at least one bus or other communication link, although other numbers and/or types of network devices may be used. The gateway devices 204(1)-204(n) in this example may process requests received from the INST device 202 via the communication network(s) 210 according to an HTTP-based and/or JavaScript Object Notation (JSON) protocol, for example, although other protocols may also be used.

The gateway devices 204(1)-204(n) may be hardware or software or may represent a system with multiple servers in a pool, which may include internal or external networks. The gateway devices 204(1)-204(n) hosts the databases 208(1)-208(n) that are configured to store information relating to a variety of gateway functions including communication data, encryption data and/or authentication data, such as encryption keys and certificates, for example.

Although the gateway devices 204(1)-204(n) are illustrated as single devices, one or more actions of each of the gateway devices 204(1)-204(n) may be distributed across one or more distinct network computing devices that together comprise one or more of the gateway devices 204(1)-204(n). Moreover, the gateway devices 204(1)-204(n) are not limited to a particular configuration. Thus, the gateway devices 204(1)-204(n) may contain a plurality of network computing devices that operate using a master/slave approach, whereby one of the network computing devices of the gateway devices 204(1)-204(n) operates to manage and/or otherwise coordinate operations of the other network computing devices.

The gateway devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 206(1)-206(n) may also be the same or similar to the computer system 102 or the computer device 120 as described with respect to FIG. 1, including any features or combination of features described with respect thereto. For example, the client devices 206(1)-206(n) in this example may include any type of computing device that can interact with the INST device 202 via communication network(s) 210. Accordingly, the client devices 206(1)-206(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 206 is a wireless mobile communication device, i.e., a smart phone.

The client devices 206(1)-206(n) may run interface applications, such as standard web browsers or standalone client applications, which may provide an interface to communicate with the INST device 202 via the communication network(s) 210 in order to communicate user requests and other information. The client devices 206(1)-206(n) may further include, among other features, a display device, such as a display screen or touchscreen, and/or an input device, such as a keyboard, for example. The client devices 206(1)-206(n) may host one or more applications that are proprietary to an enterprise that is secure from eavesdropping, and these applications may be distributed among client devices 206(1)-206(n). The enterprise's distributed applications may include software that is based on microservices architecture

Although the exemplary network environment 200 with the INST device 202, the gateway devices 204(1)-204(n), the client devices 206(1)-206(n), the databases 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the INST device 202, the gateway devices 204(1)-204(n), the client devices 206(1)-206(n), and the databases 208(1)-208(n), for example, may be configured to operate as virtual instances on the same physical machine. In other words, one or more of the INST device 202, the gateway devices 204(1)-204(n), the client devices 206(1)-206(n), and the databases 208(1)-208(n) may operate on a common physical device rather than as separate devices communicating through communication network(s) 210. Additionally, there may be more or fewer server devices 204(1)-204(n), client devices 206(1)-206(n) and databases 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

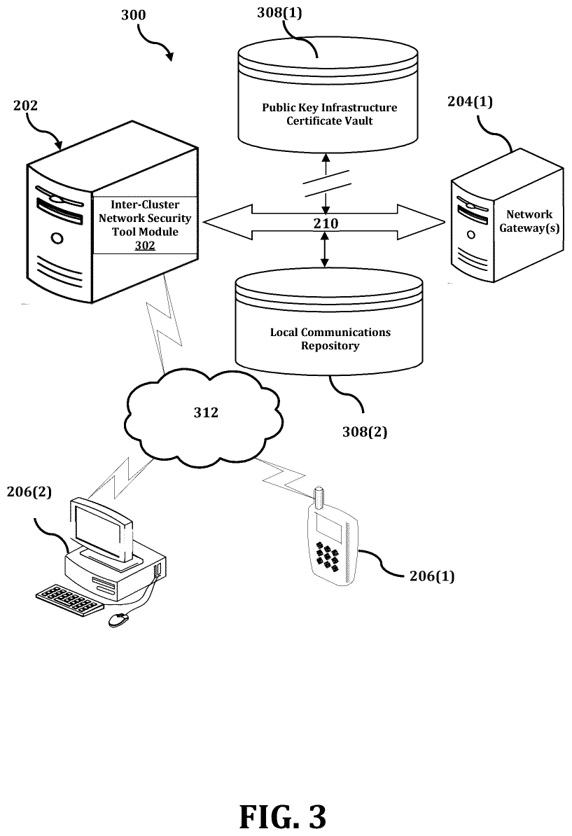

The INST device 202 is described and illustrated in FIG. 3 as including inter-cluster network security tool module 302, although it may include other rules, policies, modules, databases, or applications, for example. As will be described below, inter-cluster network security tool module 302 is configured to rectify at least one network data server infrastructure common cause failure issue. Inter-cluster network security tool module 302 may include software that is based on microservices architecture.

Inter-cluster network security tool module 302 may be integrated with one or more devices or apparatuses, such as client devices 206(1)-206(n), where inter-cluster network security tool module 302 may be implemented as an application or as an addon or plugin to another application of the one or more devices or apparatuses, and where inter-cluster network security tool module 302 may execute in the background.

An exemplary configuration 300 for applying an inter-cluster network security tool to an aspect of the network environment of FIG. 2 is illustrated as being executed in FIG. 3. Specifically, a first client device 206(1) and a second client device 206(2) are illustrated as being in communication with INST device 202. In this regard, the first client device 206(1) and the second client device 206(2) may be “clients” of the INST device 202 and are described herein as such. Nevertheless, it is to be known and understood that the first client device 206(1) and/or the second client device 206(2) need not necessarily be “clients” of the INST device 202, or any entity described in association therewith herein. Any additional or alternative relationship may exist between either or both of first client device 206(1), second client device 206(2) and INST device 202.

INST device 202 may store communications from the communication network(s) 210 onto Local Communications Repository 308(2). However, the Public Key Infrastructure Vault 308(1) is inaccessible via the communication network(s) 210, and the Public Key Infrastructure Vault 308(1) an only be accessed by the INST device 202 via a physically secure and/or virtually secure (e.g., encrypted and/or authenticated) private channel In an embodiment, the INST device 202 may comprise the Public Key Infrastructure Vault 308(1), and the private channel may be an internal channel of the INST device 202. In addition, inter-cluster network security tool module 302 of INST device 202 may also communicate with the Local Communications Repository 308(2).

In an embodiment, inter-cluster network security tool module 302 may be configured to provide a dynamically customizable interface for selecting at least one gateway device to communicate with from among gateway devices 204(1)-204(n). Moreover, INST device 202 may receive and transmit data via communication network(s) 210. INST device 202 may receive and transmit data such as code that is written in one or more of the following dialects: transaction control language (TCL), data manipulation language (DML), data control language (DCL) and data definition language (DFL). Additionally, via communication network(s) 210, INST device 202 may respectively receive and transmit data from and to one or more from among the gateway devices 204(1)-204(n) and first client devices 206(1)-206(n).

However, FIG. 3 depicts the first client device 206(1) and the second client device 206(2) as belonging to a local cluster 312, and INST device 202 may communicate with any one or more devices or apparatuses that belong to the local cluster 312, such as one or more from among client devices 206(1)-206(n). In an embodiment, the local cluster 312 may comprise a cluster that belongs to the above-mentioned enterprise that is secure from eavesdropping. In a further embodiment, local cluster 312 may comprise a cluster of distributed applications that belong to the enterprise.

The first client device 206(1) may be, for example, a smart phone. Of course, the first client device 206(1) may be any additional device described herein. The second client device 206(2) may be, for example, a personal computer (PC). Of course, the second client device 206(2) may also be any additional device described herein.

The client devices 206(1)-206(n) may represent, for example, computer systems of the enterprise's client network. The first client device 206(1) may represent, for example, one or more computer systems of a client or of a cluster of clients within the enterprise or client network. Of course, the first client device 206(1) may include one or more of any of the devices described herein. The second client device 206(2) may be, for example, one or more computer systems of another client or cluster of clients within the enterprise or client network. Of course, the second client device 206(2) may include one or more of any of the devices described herein.

The process may be executed via the communication network(s) 210, which may comprise plural networks as described above. For example, in an exemplary embodiment, either or both of the first client device 206(1) and the second client device 206(2) may communicate with the INST device 202 via broadband or cellular communication. Of course, these embodiments are merely exemplary and are not limiting or exhaustive.

Inter-cluster network security tool module 302 may programmatically facilitate private communications between a local distributed application cluster, such as cluster 312, and gateway devices 204(1)-204(n), which may respectively correspond to remote clusters of distributed applications within an enterprise, such as the enterprise mentioned above.

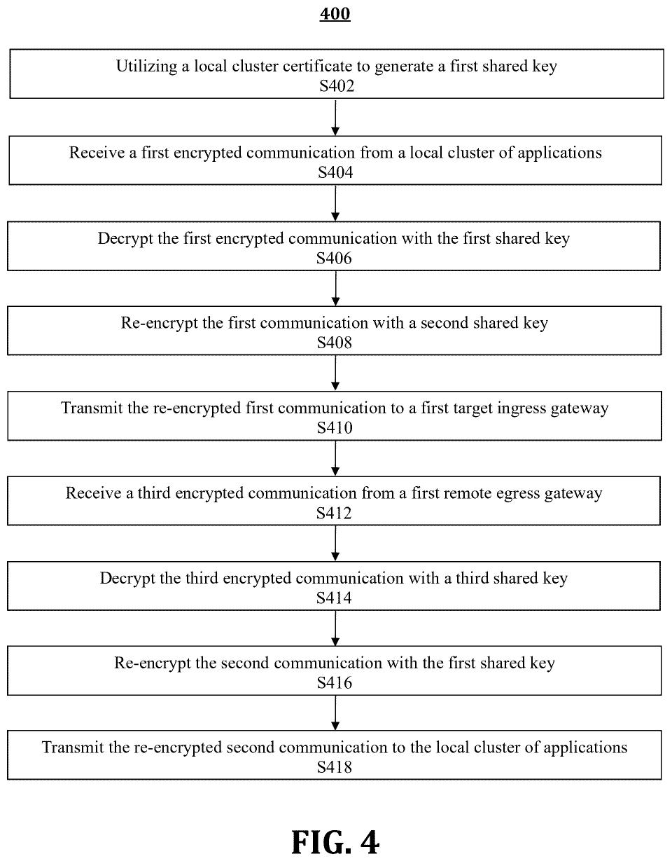

Inter-cluster network security tool module 302 may execute a process that programmatically facilitates private communications between a local distributed application cluster and one or more gateway devices from among gateway devices 204(1)-204(n). An exemplary process for an inter-cluster network security tool is generally indicated at flowchart 400 in FIG. 4.

In process 400 of FIG. 4, at step S402, inter-cluster network security tool module 302 utilizes a first local cluster certificate to generate a first shared key at a first inter-cluster egress gateway. Subsequently, at step S404, inter-cluster network security tool module 302 receives a first encrypted communication at the first inter-cluster egress gateway. Inter-cluster network security tool module 302 may receive the first encrypted communication from at least one first local application from among a local cluster of applications, such as cluster 312, for example. This local cluster of applications may be a cluster of distributed applications that belong to an enterprise that is secure from eavesdropping. In an embodiment, the enterprise may utilize infrastructure, such as the Internet, which may be vulnerable to eavesdropping, spoofing and/or other unwanted behaviors, for example.

The first encrypted communication may have been generated by the at least one first local application by utilizing a first shared key to encrypt a first communication. Additionally, at step S402, the at least one first local application may utilize a second local cluster certificate to generate the shared key. In an embodiment, the local cluster of applications (including the at least one first local application) may be running on and/or hosted by one or more client devices from among client devices 206(1)-206(n) (such as client devices 206(1) and 206(2), for example).

During step S402, inter-cluster network security tool module 302 may utilize the first local cluster certificate to mutually authenticate with the local cluster of applications (namely, the at least one first local application, for example) while the local cluster of applications utilizes the second cluster certificate to perform the mutual authentication. Accordingly, in an embodiment, step S402 may be configured to require that the local cluster of applications and inter-cluster network security tool module 302 successfully mutually authenticate with one another before the inter-cluster network security tool module 302 and the at least one first local application are actually permitted to generate the shared key.

Thereafter, during step S404, the at least one first local application transmits, and inter-cluster network security tool module 302 accepts, the first encrypted communication. For example, the mutual authentication process described herein may comprise a transport layer security (TLS) mutual authentication procedure (e.g., mTLS). In another example, the mutual authentication procedure described herein may comprise an internet protocol security (IPSec) mutual authentication procedure.

At step S406, inter-cluster network security tool module 302 reproduces the first communication by utilizing the first shared key to decrypt the first encrypted communication. In an embodiment, the first communication is reproduced at the first inter-cluster egress gateway. The first local cluster certificate and the second local cluster certificate may be generated by a local cluster certificate authority that is implemented within the local cluster of applications.

During step S406, after reproducing the first communication, inter-cluster network security tool module 302 may also determine one or more destinations of the first communication and verify that the local cluster of applications (namely, the at least one first local application, for example) is authorized to transmit the first communication to the one or more destinations of the first communication.

Accordingly, in an embodiment, step S406 may be configured to require that the local cluster of applications is authorized to communicate the first communication with the first communication's one or more destinations before the inter-cluster network security tool module 302 is actually permitted to re-encrypt the first communication and transmit it to at least one authorized destination from among its one or more destinations.

In an embodiment, during step S406, inter-cluster network security tool module 302 may utilize a header of the first communication to determine one or more of the first communication's destinations. For example, in the embodiment, the header may comprise at least one server name indication (SNI) that identifies one or more of the first communication's destinations.

At step S408, inter-cluster network security tool module 302 generates a second encrypted communication by utilizing a first enterprise certificate to generate a second shared key and utilizing the second shared key to re-encrypt the first communication. In an embodiment, the second communication is generated at the first inter-cluster egress gateway.

The first local cluster certificate and the second local cluster certificate may be managed by a control plane. In an embodiment, the control plane may belong to the enterprise, and/or the control plane may be distributed among a set of application clusters that comprises the local cluster of applications mentioned above.

During step S408, generating the second encrypted communication may further include appending, to the re-encrypted first communication, a header that identifies a destination of the first communication and corresponds to an authorized gateway device 204(x). Moreover, generating the second encrypted communication may also include obtaining a first identifier of the at least one first local application from the header of the first encrypted communication and populating the header of the second encrypted communication with the first identifier.

According to process 400, the first identifier may comprise at least one from among at least one first internet protocol (IP) address of the at least one first local application and at least one identifier of the first local cluster certificate.

According to embodiments, cluster-to-IP address mappings may be utilized, at the destination of the first communication, to determine which cluster corresponds to the at least one first IP address. Thereby, the destination of the first communication may identify the first communication's source, although the second encrypted communication may identify inter-cluster network security tool module 302 as the second encrypted communication's source.

In an embodiment, during preliminary steps, the control plane may configure and subsequently deploy inter-cluster network security tool module 302 and gateway device(s) 204(1)-204(n). The control plane may configure the inter-cluster network security tool module 302 by provisioning the inter-cluster network security tool module 302 and a corresponding set of database(s), which may comprise a public key infrastructure certificate vault and/or local communications repository, such as 308(1) and/or 308(2), for example. Similarly, during preliminary steps, the control plane may also configure and subsequently deploy the gateway device(s) 204(1)-204(n) and their respectively corresponding sets of database(s) 208(1)-208(n), and each such database 208 may comprise its own corresponding public key infrastructure certificate vault and local communications repository.

At step S410, inter-cluster network security tool module 302 transmits (from the first inter-cluster egress gateway) the second encrypted communication to at least one target gateway device (such as one from among gateway devices 204(1)-204(n), for example) which may each respectively correspond to at least one target distributed application cluster from among the set of distributed application clusters. The at least one target gateway device may comprise a first target gateway device that includes a first target ingress gateway and a first target egress gateway. In an embodiment, the second encrypted communication may be transmitted to the first target egress gateway.

During step S410, inter-cluster network security tool module 302 may utilize the first enterprise certificate to mutually authenticate with the first target gateway device (while the first target gateway device utilizes the second enterprise certificate for such mutual authentication). Accordingly, in an embodiment, step S410 may be configured to require that the first target gateway device and inter-cluster network security tool module 302 successfully mutually authenticate with one another before the inter-cluster network security tool module 302 and the first target gateway device are actually permitted to generate the second shared key. Thereafter, during step S410, inter-cluster network security tool module 302 transmits, and the first target gateway accepts, the second encrypted communication.

At step S412, inter-cluster network security tool module 302 receives (at a first inter-cluster ingress gateway) a third encrypted communication from a first remote gateway (such as one from among gateway devices 204(1)-204(n), for example) that corresponds to a first remote distributed application cluster from among the set of distributed application clusters. The first remote gateway may refer to either the first target gateway device (e.g., 204(1)) or a second gateway device (e.g., 204(2)).

The third encrypted communication may have been generated by the first remote gateway by utilizing a third enterprise certificate to generate a third shared key and utilizing the third shared key to encrypt a second communication. In an embodiment, the set of distributed application clusters (including the first remote distributed application cluster) may be running on and/or hosted by one or more client devices from among client devices 206(1)-206(n) (such as client devices 206(1) and 206(2), for example).

During step S412, inter-cluster network security tool module 302 may utilize the first enterprise certificate to mutually authenticate with the first remote gateway device (while the first remote gateway device may utilize a third enterprise certificate for such mutual authentication).

Accordingly, in an embodiment, step S412 may be configured to require that the first remote gateway device and inter-cluster network security tool module 302 successfully mutually authenticate with one another before the inter-cluster network security tool module 302 and the first remote gateway device are actually permitted to generate the third shared key. Thereafter, during step S412, the first remote gateway device transmits, and inter-cluster network security tool 302 accepts, the third encrypted communication.

At step S414, inter-cluster network security tool module 302 reproduces the second communication by utilizing the third shared key to decrypt the third encrypted communication. In an embodiment, the second communication is reproduced at the first inter-cluster ingress gateway. For example, the first enterprise certificate and the second enterprise certificate may be generated by an enterprise certificate authority that is proprietary to the enterprise. The enterprise certificate authority may be included within (e.g., as part of) the control plane.

Accordingly, the above-mentioned local cluster certificate authority and enterprise certificate authority respectively generate local cluster certificates and enterprise certificates that are specific to the local cluster certificate authority and enterprise certificate authority, respectively. The processing resources (including authentication, encryption, and decryption resources, etc.) required to exchange information may be significantly reduced by this approach and, thereby, the invention described herein facilitates optimized private communications within an environment that is vulnerable to eavesdropping, spoofing and/or other unwanted behaviors, for example.

During step S414, after reproducing the second communication, inter-cluster network security tool module 302 may also determine one or more destinations of the second communication and verify that the first remote gateway (namely, the first remote distributed application cluster, for example) is authorized to transmit the second communication to the one or more destinations of the second communication.

Accordingly, in an embodiment, step S414 may be configured to require that the first remote distributed application cluster is authorized to communicate the second communication with the local cluster of distributed applications before the inter-cluster network security tool module 302 is actually permitted to re-encrypt the second communication and transmit it to the local cluster of distributed applications. In an embodiment, during step S414, inter-cluster network security tool module 302 may utilize a header of the second communication to determine one or more of the first communication's destinations (e.g., one or more applications from among the local cluster of applications).

At step S416, inter-cluster network security tool module 302 generates a fourth encrypted communication by utilizing the first shared key to re-encrypt the first communication. In an embodiment, the fourth encrypted communication is generated at the first inter-cluster ingress gateway.

During step S416, generating the fourth encrypted communication may further include appending, to the re-encrypted second communication, a header that identifies a destination of the second communication (namely, at least one application from among the local cluster of applications that corresponds to a local gateway device that comprises the first inter-cluster egress gateway and the first inter-cluster egress gateway).

According to embodiments, generating the fourth encrypted communication may also include obtaining a second identifier, which identifies a source of the second communication, from the header of the third encrypted communication and populating the header of the fourth encrypted communication with the second identifier. In embodiments, the second identifier may comprise at least one from among an IP address of the source of the second communication and at least one identifier of a remote cluster certificate of the source.

According to embodiments, an application from among the local cluster of applications, may utilize the cluster-to-IP address mappings mentioned above, to determine that the source's IP address is assigned to a remote distributed application from among the first remote distributed application cluster. Thereby, the application of the local cluster may identify the second communication's source, although the third encrypted communication may identify the first remote gateway as the third encrypted communication's source.

At step S418, inter-cluster network security tool module 302 transmits (from the first inter-cluster ingress gateway) the fourth encrypted communication to at least one local application from among the local distributed application cluster (which may be running on one or more devices from among client devices 206(1)-206(n), for example). The at least one local application may refer to at least one from among: the at least one first local application and a second local application from among the local cluster of applications.

During step S418, inter-cluster network security tool module 302 may utilize the first local cluster certificate to mutually authenticate with the local cluster of applications (namely, the at least one local application, for example) while the local cluster of applications may utilize the first cluster certificate for such mutual authentication.

Accordingly, in an embodiment, step S418 may be configured to require that the local cluster of applications and inter-cluster network security tool module 302 successfully mutually authenticate with one another before the inter-cluster network security tool module 302 is actually permitted to transmit (which may comprise: (i) transmitting by the inter-cluster network security tool module 302; and (ii) accepting by the local cluster of applications) the fourth encrypted communication to the application from among the local cluster of applications (e.g., the at least one local application).

According to embodiments of the subject matter disclosed herein, a superset of clusters may comprise each cluster within a network of the inter-cluster network security tool module 302, and the cluster-to-IP address mappings mentioned above may identify each cluster from among the superset of clusters and may associate each cluster with respectively corresponding IP address ranges that are assigned to each cluster, respectively.

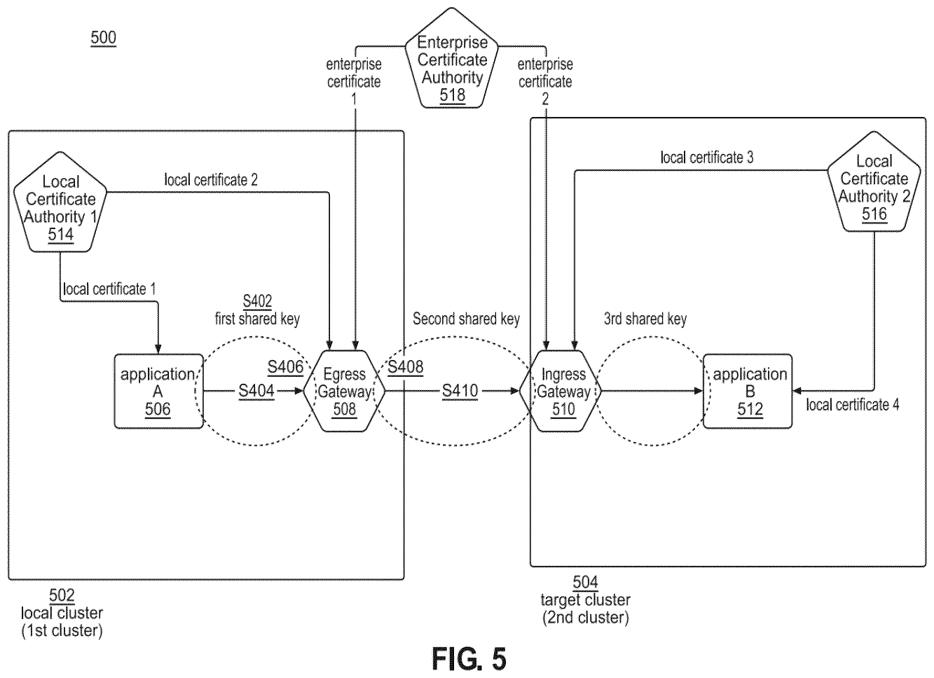

According to an implementation of the present invention, an exemplary perspective of an enterprise network environment 500 that facilitates private communications between enterprise clusters that do not trust one another, is generally depicted in FIG. 5.

As depicted in FIG. 5, enterprise network environment 500 comprises a first cluster 502 of private enterprise applications that trust one another (such as the “local cluster of applications” described above with respect to process 400, for example). In addition, enterprise network environment 500 also comprises a second cluster 504 of private enterprise applications that trust one another (such as a first target distributed application cluster that corresponds to the “first target ingress gateway” and the “first target egress gateway” that are described above with respect to process 400). However, it should be noted that the private enterprise applications of the first cluster 502 do not trust the private enterprise applications of the second cluster 504 and vice-versa.

Although not depicted in FIG. 5, enterprise network environment 500 may further comprise a third cluster of private enterprise applications, such as the first remote distributed application cluster described above with respect to process 400, it should also be noted that enterprise network environment 500 may comprise any number of distinct enterprise application clusters that do not trust one another.

As depicted in FIG. 5, the first cluster 502 comprises application 506 (i.e., application A), which may be a distributed application such as the “at least one first local application” described above with respect to process 400, for example. Similarly, FIG. 5 depicts the second cluster 504 as comprising application 512 (i.e., application B).

FIG. 5 also depicts egress gateway 508 (which may comprise the “first inter-cluster egress gateway” described above with respect to process 400, for example) and ingress gateway 510 (which may comprise the “first target ingress gateway” described above with respect to process 400, for example). Moreover, FIG. 5 further depicts a plurality of distinct certificate authorities that include local certificate authority 514 (i.e., local certificate authority 1), local certificate authority 516 (i.e., local certificate authority 2), and enterprise certificate authority 518, which each respectively generate their own distinct digital certificates.

Local certificate authority 514 may generate a respectively distinct local certificate for egress gateway 508 and each application from among the first cluster 502 of private enterprise applications. Accordingly, egress gateway 508 and each application from among the first cluster 502 may each utilize their respectively distinct local certificate to mutually authenticate and privately communicate with one another within the first cluster 502.

As depicted in FIG. 5, local certificate authority 514 may generate a local certificate 1 (such as the “second local cluster certificate” described above with respect to process 400, for example) and a local certificate 2 (such as the “first local cluster certificate” described above with respect to process 400, for example), and local certificate authority 514 may privately assign local certificate 1 and local certificate 2 to application 506 and egress gateway 508, respectively.

Similarly, FIG. 5 also depicts that local certificate authority 516 may generate a local certificate 3 and a local certificate 4, and FIG. 5 further depicts that local certificate authority 516 may privately assign local certificate 3 and local certificate 4 to ingress gateway 510 and application 512, respectively. Moreover, FIG. 5 depicts that enterprise certificate authority 518 generates an enterprise certificate 1 (such as the “first enterprise certificate” described above with respect to process 400, for example) and an enterprise certificate 2 (such as the “second enterprise certificate” described above with respect to process 400, for example), and FIG. 5 further depicts that enterprise certificate authority 518 may privately assign enterprise certificate 1 and enterprise certificate 2 to egress gateway 508 and ingress gateway 510, respectively.

According to the present invention, every certificate that is generated must be kept confidential, and a new certificate must be generated by the appropriate certificate authority to replace any certificate that is compromised through disclosure to an entity other than: (i) the certificate authority (e.g., “local certificate authority 514”, “local certificate authority 516”, “enterprise certificate authority 518”, etc.) that generated the compromised certificate; and (ii) the entity (e.g., “application 506”, “egress gateway 508”, “ingress gateway 510”, “application 512”, etc.) to which such the compromised certificate was assigned.

According to the present invention, application 506 and egress gateway 508 may each utilize their own respectively distinct local certificate (namely, local certificate 1 and local certificate 2, respectively) to mutually authenticate and privately communicate with each other. For example, as depicted in FIG. 5, application 506 and egress gateway 508 mutually authenticate and, subsequently, application 506 and egress gateway 508 each utilize their own respectively distinct local certificate to generate a first shared key according to step S402 of process 400.

FIG. 5 also depicts a communication that is transmitted from application 506 and received by egress gateway 508 according to step S404 of process 400. After step S404, egress gateway 508 may utilize a header of the communication that was received according to step S404, to determine that the received communication is intended to be transmitted from the first cluster 502 to the second cluster 504. Additionally, after step S404, egress gateway 508 may verify that the first cluster 502 is authorized to transmit the received communication to the second cluster 504.

As further depicted in FIG. 5, egress gateway 508 performs operations according to step S406 of process 400 to utilize the first shared key to decrypt the communication received at step S404. Subsequently (or during a provisional stage, e.g., step S402), egress gateway 508 and ingress gateway 510 may authenticate each other and each utilize their respective enterprise certificates (namely, enterprise certificate 1 and enterprise certificate 2, respectively) to generate a second shared key. According to the present invention, enterprise certificate authority 518 generates and assigns a respectively distinct enterprise certificate to each authorized gateway (e.g., egress gateway 508 and ingress gateway 510) that exists within an enterprise.

For example, as depicted in FIG. 5, enterprise certificate authority 518 generates enterprise certificate 1 and enterprise certificate 2, and enterprise certificate authority 518 subsequently assigns enterprise certificate 1 and enterprise certificate 2 to egress gateway 508 and ingress gateway 510, respectively. Also, as depicted in FIG. 5, egress gateway 508 performs operations according to step S408 of process 400 to utilize the second shared key to re-encrypt the communication that is decrypted at step S406 and, as FIG. 5 further depicts, egress gateway 508 transmits the re-encrypted communication (e.g., the “second encrypted communication”) to ingress gateway 510 according to step S410 of process 400.

According to implementations of the present invention, ingress gateway 510 may utilize the second shared key to decrypt the re-encrypted communication that ingress gateway 510 received from egress gateway 508 according to step S410 of process 400, for example. Subsequently, ingress gateway 510 may utilize a “3rd shared key” to encrypt this decrypted communication for transmission to the second cluster 504's application 512. Unlike the “third shared key” described above with respect to process 400, the “3rd shared key” described here with respect to enterprise environment 500, is generated by ingress gateway 510 and application 512 after they authenticate each other, and ingress gateway 510 and application 512 respectively utilize local certificate 3 and local certificate 4 to independently generate the “3rd shared key.”

According to implementations of the present invention, the operations described above and depicted in FIG. 5 may also be performed mutatis mutandis to transmit a communication from application 512 and to ultimately receive such transmitted communication at application 506.

It should be noted that according to implementations of the present invention, each enterprise cluster's egress gateway and ingress gateway may comprise an inter-cluster network security tool that utilizes a common enterprise certificate to perform egress gateway operations and ingress gateway operations. It should also be noted that according to other implementations, each enterprise cluster's egress gateway and ingress gateway may comprise an inter-cluster network security tool that utilizes distinct enterprise certificates to perform egress gateway operations and ingress gateway operations, respectively.

In implementations of the present invention, process 400 may be performed according to a standard communication protocol, such as at least one from among mTLS and IPSEC, for example.

In an embodiment, the invention described herein includes a “service mesh,” which is an abstraction layer that configures functionality such as the following, onto a declarative configuration layer: service-to-service communication (e.g., service discovery, encryption, etc.), observability (e.g., monitoring, tracing, etc.), and resiliency (circuit-breakers, retries, etc.). The “service mesh” of the invention presented herein may consist of a “control plane” and a “data plane”that are utilized to orchestrate service mesh functionality.

In the embodiment, the “control plane” may comprise a “central manager” that “defines policies, orchestrates the data plane, and collecting telemetry,” and the “data plane” may comprise an array of lightweight network proxies (e.g., sidecar proxies) that are deployed alongside distributed application instances to intercept all network traffic to enforce policies defined within the control plane. The control plane may output network traffic logs and network traffic metrics, and the control plane may also perform service mesh functionalities (e.g., discovery, health checks, authentication, load balancing, etc.) on behalf of application service.

A “sidecar proxy” refers to a self-contained process that is designed to run alongside application servers. Sidecar proxies collectively form a transparent communication mesh via which applications may send messages to and receive messages from one another. Accordingly, no network topology information is required for the herein-described invention's applications to communicate with one another.

The invention described herein may also include a plurality of ingress/egress gateways, which may perform load balancing operates and may be located at the edge of a compute cluster's service mesh in order to receive the compute cluster's incoming/outgoing HTTP/TCP communications. Accordingly, the service mesh provided herein facilitates communication between application services. The service mesh's sidecar proxies may capture all the ingress and egress communications for their respective computer clusters. The control plane may configure its sidecar proxies to route their traffic to its intended destination (target compute cluster(s)).

According to an embodiment of the invention provided herein, ingress/egress gateways (such as, inter-cluster network security tool module 302 and gateway devices 204(1)-204(n), for example) may be provisioned with their respective PKI certificates (namely, enterprise identity certificates) by an enterprise identity certificate authority (CA), which may also generate the PKI certificates (e.g., the enterprise identity certificates) and then utilize a service mesh (such as the service mesh mentioned above) to provision each gateway with its own distinct and confidential PKI certificate. Thereby, each gateway may be provisioned with its own verifiable enterprise-wide certificate-based identifier (such as a digital signature and/or a leaf PKI certificate, for example). It should be noted that for the purposes of this disclosure, “leaf certificates”refer to certificates that cannot be utilized to sign another certificate.

The service mesh control plane may also be utilized to host a self-signed identity CA that may mint certificates for an application cluster's application sidecar and its corresponding ingress/egress gateway, and the service mesh may also be utilized to provision such an application sidecar and/or corresponding ingress/egress gateway with its own distinct self-signed identity certificate (e.g., a local cluster identity certificate) in order to securely communicate communications that correspond to the application sidecar and/or its corresponding cluster of applications. These certificates may be utilized to encrypt all the traffic corresponding to the application cluster. Thereby, the self-signed identity may act as a source of trust within the compute cluster (i.e., cluster of applications) despite providing no utility to communications unrelated to the cluster of applications.

In an embodiment, the control plane may be utilized to accessed configuration details, such as lists of compute clusters where the applications are deployed, services that have requirements to be consumed from other clusters and vice versa, and names of the services that can be accessed via the gateways. In the embodiment, the management plane may be utilized to configure each computer cluster's service mesh control plane.

The service mesh's control plane may also be utilized to configure a sidecar proxy, which the control plane may configure to redirect traffic to at least one external service via a corresponding egress gateway of the sidecar proxy. The service mesh's control plane may also be utilized to configure an ingress gateway and an egress gateway. The control plane may configure the egress gateway to accept traffic originating from within a sidecar's compute cluster of applications, and the control plane may also configure the egress gateway to decrypt and validate the source and destination of the traffic. Moreover, the control plane may configure the egress gateway to re-encrypt the traffic with an enterprise certificate.

In an embodiment, a first compute cluster service may initiate a first communication with a second compute cluster service, by transmitting the first communication to a first cluster-specific sidecar proxy of the first compute cluster. In response to receiving the first transmission, the first cluster-specific sidecar proxy may utilize a self-signed certificate to encrypt the first communication and then transmit the encrypted first communication to the first cluster's cluster-specific enterprise egress gateway. In the embodiment, a local instance of the enterprise's service mesh control plane may have been utilized to configure the first cluster-specific sidecar proxy with the self-signed certificate during a provisional stage. In response to receiving the encrypted first communication, the egress gateway may decrypt and validate the encrypted first communication. Upon successfully validating the first communication, the egress gateway may utilize the egress gateway's enterprise certificate to re-encrypt the first communication and then transmit the re-encrypted first communication outside of the first cluster to the appropriate cluster-specific enterprise ingress gateway.

Therefore, according to the invention described herein, an ingress gateway may be utilized to decrypt and validate incoming traffic. Upon successfully validating such traffic, the ingress gateway may re-encrypt the incoming traffic with the local cluster's self-signed certificate. Thereby, a compute cluster's incoming traffic may be accepted by a destination sidecar proxy of a destination service and then forwarded to the destination service by the sidecar proxy.

In an embodiment, when a first cluster chooses to communicate with a second cluster, the first cluster sends the traffic to its sidecar proxy, which is a sidecar proxy that is dedicated to the first cluster. The sidecar proxy for the first cluster may encrypts the traffic using a self-signed certificate of the first cluster, and the self-signed certificate of the first cluster may have been received from the service mesh's local control plane corresponding to the first cluster. Subsequently, the encrypted traffic may be transmitted to the egress gateway of the first cluster.

Once the encrypted traffic is received, the egress gateway may decrypt and validate the traffic. Upon successfully validating the traffic, the egress gateway may then utilize its enterprise certificate to re-encrypt the traffic and then transmit the re-encrypted traffic to its destination ingress gateway(s). Thereby, traffic may be transmitted outside of the first cluster.

The destination ingress gateway(s) may decrypt and validate incoming traffic. Upon successfully validating the incoming traffic, the destination ingress gateway(s) may utilize its own local cluster's self-signed certificate to re-encrypt the incoming traffic. Subsequently, this incoming traffic may be transmitted to the corresponding destination sidecar proxy, which may in turn transmit the incoming traffic to an application from among a destination cluster (e.g., a second cluster).

In an embodiments, requests may transmitted to the enterprise's identity CA service, which may dynamically scale its resources to conserve resources or to support higher workloads because these workloads can change frequently and each change may cause the identity CA service to consume resources by performing an attestation operation.

In an embodiment, to reduce the number of attestation operations that it is required to perform, the enterprise's identity CA service may only issue certificates to gateways that restart relatively infrequently in comparison to other gateways of the enterprise's identity CA. Additionally, each local cluster's self-signed identity CA service may issue distinct and confidential local cluster identity certificates to each device in the cluster, thereby relieving the enterprise's identity CA service from having to perform these attestations by delegating them to the local cluster's identity CA service.

For example, the enterprise identity CA may only be responsible for issuing 4 certificates, namely the gateways for a first compute cluster and a second compute cluster. To specific, the enterprise identity CA may only be responsible for assigning a respectively corresponding, distinct and confidential certificate to each from among: a first egress gateway, a first ingress gateway, a second egress gateway, and a second ingress gateway. On the other hand, the cluster local identity CA is responsible for issuing a respectively corresponding, distinct and confidential certificate to each from among: the processes of the compute cluster, and its egress gateway and ingress gateway.

Accordingly, the improvement described herein effectively distributes the resources required for an enterprise's communication network(s), and this has the effect of exponentially reducing the number of resources required by the enterprise (e.g., the enterprise identity CA service) as the size of that enterprise increases, which is particularly useful to large communication networks (e.g., the communication network(s) of a global enterprise). Therefore, the approach provided herein eliminates the need to authenticate application certificates with the enterprise identity CA by relying on a cluster-specific, self-signed identity CA instead. The novel solution described herein utilizes ingress and egress gateways as a type of trust broker for all intra-cluster communications. As trust broker for intra-cluster communications, the ingress and egress gateways may utilize their cluster's self-signed identity CA in combination with the enterprise identity CAs to secure the cluster's intra-cluster communications.

Therefore, utilizing self-signed identity CAs prevents the enterprise from having to create lager numbers of intermediate CAs, which would siphon the enterprise's required control over the underlying attestation process away from the enterprise. In an embodiment, the novel approach described herein may utilize a header feature, such as a server name indication (SNI) header of a transmission control protocol (TCP), to ensure that the enterprise network's traffic includes an identification of its original source and/or destination for the verification and routing of all traffic. Moreover, the novel approach described herein may also provide improved security against unauthorized connections and or communications, by requiring that each application within an enterprise's clusters identify an intended source and destination for each connection and/or communication that is established on the enterprise's network.

In an embodiment of the invention described herein, the enterprise's service mesh may configure each of the enterprise's clusters'corresponding sidecar proxy to intercept all ingress and egress traffic relating to the application(s) within its cluster. Thereby, the enterprise's sidecar proxies may manage the enterprise's network traffic and encrypt/decrypt such traffic on behalf of the cluster's application(s). According to the approach described herein, the management plane may configure the enterprise's service mesh to orchestrate traffic across all the enterprise's compute clusters, whereby the enterprise identity CA service provides enterprise certificates to the enterprise's ingress and egress gateways.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for implementing an inter-cluster network security tool that facilitates private communications between a first private distributed application cluster and a set of private distributed application clusters within a secured enterprise network, the method comprising:
utilizing, at a first inter-cluster egress gateway, a first local cluster certificate to generate a first shared key;
receiving, at the first inter-cluster egress gateway and from at least a first distributed application of the first private distributed application cluster within the secured enterprise network, a first encrypted communication, wherein the first encrypted communication has been generated by utilizing the first shared key to encrypt a first communication;
reproducing, at the first inter-cluster egress gateway, the first communication by utilizing the first shared key to decrypt the first encrypted communication;
generating, at the first inter-cluster egress gateway, a second encrypted communication by utilizing a first enterprise certificate to generate a second shared key and utilizing the second shared key to re-encrypt the first communication; and
transmitting the second encrypted communication to a first target inter-cluster ingress gateway that respectively corresponds to a first target private distributed application cluster from among the set of private distributed application clusters.

2. The method of claim 1, wherein the first local cluster certificate is securely registered within a distributed enterprise control plane that configured the first inter-cluster egress gateway with the first local cluster certificate and the first enterprise certificate.

3. The method of claim 1, further comprising:
before generating the first shared key, mutually authenticating with the at least the first distributed application and utilizing a first encrypted session to communicate with the at least the first distributed application, and
wherein the transmitting the second encrypted communication comprises: before generating the second shared key, utilizing the first enterprise certificate to mutually authenticate with the first target inter-cluster ingress gateway and utilizing a second encrypted session to communicate with the first target inter-cluster ingress gateway.

4. The method of claim 1, wherein the first enterprise certificate and at least a second enterprise certificate are generated by an enterprise certificate authority.

5. The method of claim 1, wherein a superset of clusters comprises each cluster within the secured enterprise network, and wherein cluster-to-internet protocol (IP) address mappings identify each cluster from among the superset of clusters and associates each cluster with respectively corresponding IP address ranges.

6. The method of claim 1, further comprising:
in response to the receiving the first encrypted communication,
determining that the first encrypted communication has been received from the at least the first distributed application;
utilizing a header of the first encrypted communication to determine that the first target private distributed application cluster is a destination of the first communication; and
before the second encrypted communication is transmitted, verifying that the at least the first distributed application is authorized to communicate with the first target private distributed application cluster.

7. The method of claim 6, wherein the generating the second encrypted communication comprises:
obtaining, from the header of the first encrypted communication, at least one from among a source certificate identifier that identifies the first local cluster certificate and a first source internet protocol (IP) address of the at least the first distributed application; and
populating a header of the second encrypted communication with the at least one from among the source certificate identifier and the first source IP address.

8. The method of claim 1, further comprising:
receiving, at a first inter-cluster ingress gateway and from a first remote inter-cluster egress gateway that corresponds to a first remote private distributed application cluster from among the set of private distributed application clusters, a third encrypted communication, wherein the third encrypted communication has been generated by utilizing a third shared key to encrypt a second communication, and wherein the third shared key has been generated by utilizing a second enterprise certificate;
reproducing, at the first inter-cluster ingress gateway, the second communication by utilizing the third shared key to decrypt the third encrypted communication;
generating, at the first inter-cluster ingress gateway, a fourth encrypted communication by utilizing the first shared key to re-encrypt the second communication; and
transmitting the fourth encrypted communication to at least one distributed application of the first private distributed application cluster.

9. The method of claim 8, wherein the at least one distributed application comprises at least one from among the at least the first distributed application and a second distributed application of the first private distributed application cluster.

10. The method of claim 8, further comprising:
before generating the third shared key, mutually authenticating with the first remote inter-cluster egress gateway; and utilizing a third encrypted session to communicate with the first remote inter-cluster egress gateway, and
wherein the transmitting the fourth encrypted communication comprises communicating with the at least one distributed application by utilizing a first encrypted session.

11. The method of claim 8,
wherein the first encrypted communication is received, by the first inter-cluster egress gateway, from a first sidecar proxy of the first private distributed application cluster,
wherein the fourth encrypted communication is transmitted, by the first inter-cluster ingress gateway, to at least one sidecar proxy of the first private distributed application cluster, and
wherein the at least one sidecar proxy comprises at least one from among the first sidecar proxy and a second sidecar proxy of the first private distributed application cluster.

12. The method of claim 8, further comprising:
in response to the receiving the third encrypted communication,
determining that the third encrypted communication has been received from the first remote inter-cluster egress gateway;
utilizing a header of the third encrypted communication to determine that the at least one distributed application is a destination of the second communication; and
before the third encrypted communication is transmitted, verifying that the first remote inter-cluster egress gateway is authorized to communicate with the at least one distributed application.

13. The method of claim 12, wherein the generating the fourth encrypted communication comprises:
obtaining, from the header of the third encrypted communication, at least one from among a remote certificate identifier that identifies a first remote cluster certificate of the first remote private distributed application cluster, and a first remote internet protocol (IP) address of the first remote private distributed application cluster; and
populating a header of the fourth encrypted communication with the at least one from among the remote certificate identifier and the first remote IP address.

14. The method of claim 13, wherein the first distributed application obtains the at least one from among the remote certificate identifier and the first remote IP address from the header of the fourth encrypted communication.

15. The method of claim 14, wherein a superset of clusters comprises each cluster within the secured enterprise network, wherein cluster-to-IP address mappings identify each cluster from among the superset of clusters and associates each cluster with respectively corresponding IP address ranges, and wherein the first distributed application utilizes the cluster-to-IP address mappings to identify which cluster of the secured enterprise network is associated with the first remote IP address.

16. A system for implementing an inter-cluster network security tool that facilitates private communications between a first private distributed application cluster and a set of private distributed application clusters within a secured enterprise network, the system comprising:
a processor; and
memory storing instructions that, when executed by the processor, cause the processor to perform operations that comprise:
utilizing, at a first inter-cluster egress gateway, a first local cluster certificate to generate a first shared key;
receiving, at the first inter-cluster egress gateway and from at least a first distributed application of the first private distributed application cluster within the secured enterprise network, a first encrypted communication, wherein the first encrypted communication has been generated by utilizing the first shared key to encrypt a first communication;
reproducing, at the first inter-cluster egress gateway, the first communication by utilizing the first shared key to decrypt the first encrypted communication;
generating, at the first inter-cluster egress gateway, a second encrypted communication by utilizing a first enterprise certificate to generate a second shared key and utilizing the second shared key to re-encrypt the first communication; and
transmitting the second encrypted communication to a first target inter-cluster ingress gateway that respectively corresponds to a first target private distributed application cluster from among the set of private distributed application clusters.

17. The system of claim 16, wherein when executed, the instructions cause the processor to perform further operations that comprise:
in response to the receiving the first encrypted communication,
determining that the first encrypted communication has been received from the at least the first distributed application;
utilizing a header of the first encrypted communication to determine that the first target private distributed application cluster is a destination of the first communication; and
before the second encrypted communication is transmitted, verifying that the at least the first distributed application is authorized to communicate with the first target private distributed application cluster.

18. The system of claim 17, wherein when executed by the processor, the instructions cause the generating the second encrypted communication to comprise:
obtaining, from the header of the first encrypted communication, at least one from among a source certificate identifier that identifies the first local cluster certificate and a first source internet protocol (IP) address of the at least the first distributed application; and
populating a header of the second encrypted communication with the at least one from among the source certificate identifier and the first source IP address.

19. A non-transitory computer-readable medium for implementing an inter-cluster network security tool that facilitates private communications between a first private distributed application cluster and a set of private distributed application clusters within a secured enterprise network, the computer-readable medium stores instructions that, when executed by a processor, cause the processor to perform operations that comprise:
utilizing, at a first inter-cluster egress gateway, a first local cluster certificate to generate a first shared key;
receiving, at the first inter-cluster egress gateway and from at least a first distributed application of the first private distributed application cluster within the secured enterprise network, a first encrypted communication, wherein the first encrypted communication has been generated by utilizing the first shared key to encrypt a first communication;
reproducing, at the first inter-cluster egress gateway, the first communication by utilizing the first shared key to decrypt the first encrypted communication;
generating, at the first inter-cluster egress gateway, a second encrypted communication by utilizing a first enterprise certificate to generate a second shared key and utilizing the second shared key to re-encrypt the first communication; and
transmitting the second encrypted communication to a first target inter-cluster ingress gateway that respectively corresponds to a first target private distributed application cluster from among the set of private distributed application clusters.

20. The computer-readable medium of claim 19, wherein a superset of clusters comprises each cluster within the secured enterprise network, and wherein cluster-to-internet protocol (IP) address mappings identify each cluster from among the superset of clusters and associates each cluster with respectively corresponding IP address ranges.
